(19) United States
(12) Patent Application Publication
(10) Pub. No.: US 2005/0268459 A1
(43) Pub. Date: Dec. 8, 2005

(54) System and method for detecting connector pin insertion in printed circuit board assemblies

(75) Inventors: Yves Le Borgne, Beaconsfield (CA); Francois Desloges, Montreal (CA); Hongbing Yin, Laval (CA)

Correspondence Address: PARKHURST & WENDEL, L.L.P., 1421 PRINCE STREET, SUITE 210, ALEXANDRIA, VA, 22314-2805, US

(73) Assignee: Original Solutions Inc., St-Laurent (CA)

(21) Appl. No.: 11/084,193

(22) Filed: Mar. 21, 2005

(30) Foreign Application Priority Data
Mar. 25, 2004 (CA) 2,461,862

(51) Int. Cl. H01R 3/00; B23P 19/00

(52) U.S. Cl. 29/825; 29/729

(57) ABSTRACT

A pin detection system detects connection pin insertion in a printed circuit board assembly. The printed circuit board assembly comprises a printed circuit board having multiple wells and one or more connectors having pins that are inserted into the wells of the printed circuit board. The system comprises a conveyer, a stage assembly and a sensor. The conveyer is provided for conveying a printed circuit board assembly under test to an optimal position for conducting inspection. The stage assembly is used for conveying the sensor to specific areas of interest of the printed circuit board assembly under test. The sensor is provided for detecting pin insertion in the wells using a laser beam.

This invention relates to a system and method for detecting connector pin insertion in printed circuit board assemblies.

### BACKGROUND OF THE INVENTION

As printed circuit board assemblies (PCBA) are increasing in size, complexity, and speed of operation, the mating of such PCBAs to one-another requires the use of high-density connector assemblies. For example, in a complex router electronic circuit application, the line-card PCBA must typically be mated to a mid-plane PCBA to perform the routing tasks once the product is deployed.

To permit such mating, the industry uses press-fit connectors that may include hundreds of pins. These connector assemblies are pressed in place on a grid of pre-drilled wells of a PCB.

The connector manufacturing process inaccuracies and the press fitting process may cause some of the pins to collapse, thus creating a defective PCBA. These defects may harm the PCBA, either when power is initially applied to the finished product, or over time, when temperature cycling may cause some of the misaligned pins to dislodge or lose contact with the wall of the wells.

PCBAs are typically subject to manual visual inspections during manufacturing in order to intercept defective ones. In some cases, automatic optical inspection or laser based measurement by triangulation are carried out.

The complexity and density of high-density connector assemblies has rendered the task of inspecting for proper assembly nearly impossible, either automatically or by manual inspection means. Thus, it is not currently possible to determine whether a pin is inserted, or whether it is inserted to the appropriate height.

It is therefore preferable to provide a system that allows inspection of PCBAs that embed such high-density connectors as part of the finished PCBA.

### SUMMARY OF THE INVENTION

It is an object of the invention to provide a novel system and method for detecting correct pin insertion in PCB assemblies that obviates or mitigates at least one of the disadvantages of existing systems.

The present invention uses a laser-based sensor to detect pin locations in wells of PCBs.

In accordance with an aspect of the invention, there is provided a pin detection system for detecting connection pin insertion in a printed circuit board assembly. The system comprises a conveyer, a stage assembly, and a sensor. The conveyer is provided for conveying the printed circuit board assembly under test at the appropriate resting place where it will be inspected. The stage assembly is used to convey the sensor to specific areas of interest of the PCBA under test for the purposes of measuring pin height information. The printed circuit board assembly comprises a printed circuit board having multiple wells and one or more connectors having pins that are inserted into the wells of the printed circuit board. The sensor is provided for detecting pin insertion in the wells using a laser beam.

In accordance with an aspect of the invention, there is provided a method of detecting connection pin insertion in a printed circuit board assembly. The method comprises the steps of conveying a printed circuit board assembly under test, the printed circuit board assembly comprising a printed circuit board having multiple wells and one or more connectors having pins that are inserted into the wells of the printed circuit board; and detecting pin insertion in the wells using a laser beam.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 is a block diagram showing a pin detection system in accordance with an embodiment of the present invention;

FIG. 2 is a block diagram showing a pin detection system suite in accordance with another embodiment of the present invention;

FIG. 3 is a schematic view showing an example of connector;

FIG. 4 is a schematic view showing an example of a well of a PCB;

FIG. 5 is a schematic view showing an example of a pin fit in the well;

FIG. 6 is a schematic views showing the operation of the pin detection system;

FIG. 7 is a graph showing an example of measurements;

FIG. 8 is a schematic plan view showing an example of a panel under test;

FIG. 9 is a schematic bottom view of the panel under test;

FIG. 10 is a schematic view showing an example of a laser beam of the pin detection system;

FIG. 11 is a diagram showing an example of a database data structure;

FIG. 12 is a graph showing an example of measurement results;

FIG. 13 is a graph showing a detailed view of measurement results;

FIG. 14 is a graph showing the detailed view indicating areas of interest; and

FIG. 15 is a photograph showing an example of a pin tip inserted in a well.

### DETAILED DESCRIPTION OF THE PREFERRED EMBODIMENTS

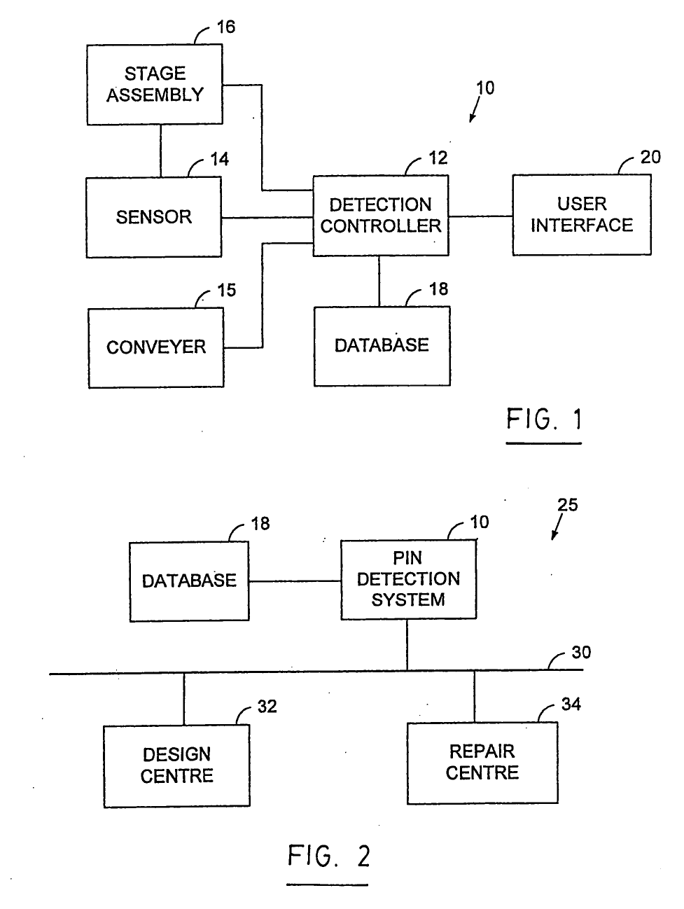

FIG. 1 shows a pin detection system 10 in accordance with an embodiment of the invention. The pin detection system 10 comprises a detection controller 12, sensor 14, conveyer 15, stage assembly 16, database 18 and user interface 20.

The pin detection system 10 is suitably used for inspection of printed circuit board assemblies (PCBAs) that embed on PCBs one or more connectors as part of the assemblies. PCBs have through holes coated with conductive materials (also referred to as “wells” hereinafter). Connectors have pins which are inserted into the through holes of PCBs. The pin detection system 10 allows inspection of pin connections during the manufacturing cycle of the PCBAs and prior to applying electric power to the PCBAs. Thus, defective PCBAs can be intercepted.

As shown in FIG. 2, the pin detection system 10 may be used as part of a defect detection system suite 25.

The defect detection system suite 25 checks for correct seating of high-density press fit connector pins in PCBAs. The pin detection system 10 performs inspection of PCBAs using templates generated with information available in PCB design files and component data sheets.

The defect detection system suite 25 comprises the pin detection system 10, a design centre 32 and repair centre 34 which are interconnected by a corporate network 30.

The design centre 32 is used by a designer to program the configuration of the PCB assemblies that will be inspected with the pin detection system 10. The design centre 32 is used to describe pins, wafers, connectors, and how those connectors are arranged on a PCB assembly panel. The design centre 32 has many features to facilitate the programming task, including the extensive use of templates.

The pin detection system 10 performs PCB assembly inspections in accordance with the program(s) that have been defined with the design centre 32. The pin detection system 10 can be used by three types of operators to ensure smooth integration of the unit in the plant operations:

The Programmer—Once the design information has been codified with the design centre 32, the pin detection system 10 is trained by the programmer to locate the panel in space and then scan the various connectors for the purposes of measuring pin height information;

The Machine Operator—Once the pin detection system 10 has been trained to inspect a particular product, the machine operator uses the pin detection system 10 to inspect panels at the appropriate point in the manufacturing process;

The Maintenance Operator—Specific on-board capabilities are used by the machine operator to rapidly assess machine readiness and fitness for use.

The repair centre 34 permits the viewing of fault information written to the product database after the panels have been inspected by the pin detection system 10. After a panel has been repaired, the operator can reclassify faults to reflect the disposition of the fault or the panel.

In the embodiment shown in FIG. 2, the design centre 32 and repair centre 34 are provided separately from the pin detection system 10. In a different embodiment, the design centre 32 and/or repair centre 34 may be integrated in the pin detection system 10.

The embodiments of the invention are further described hereinafter in connection with inspection of a PCBA having press fit connectors.

The invention may be used for PCBAs having different type of connectors whose pins are inserted into through hole of PCBs. Connectors are press fit using a press, such as a computer-controlled servo-electric presses. By inspecting all press fit pins, the pin detection system 10 allows further processing of only those PCBAs that have the press-fit pins seated correctly and are at the right depths.

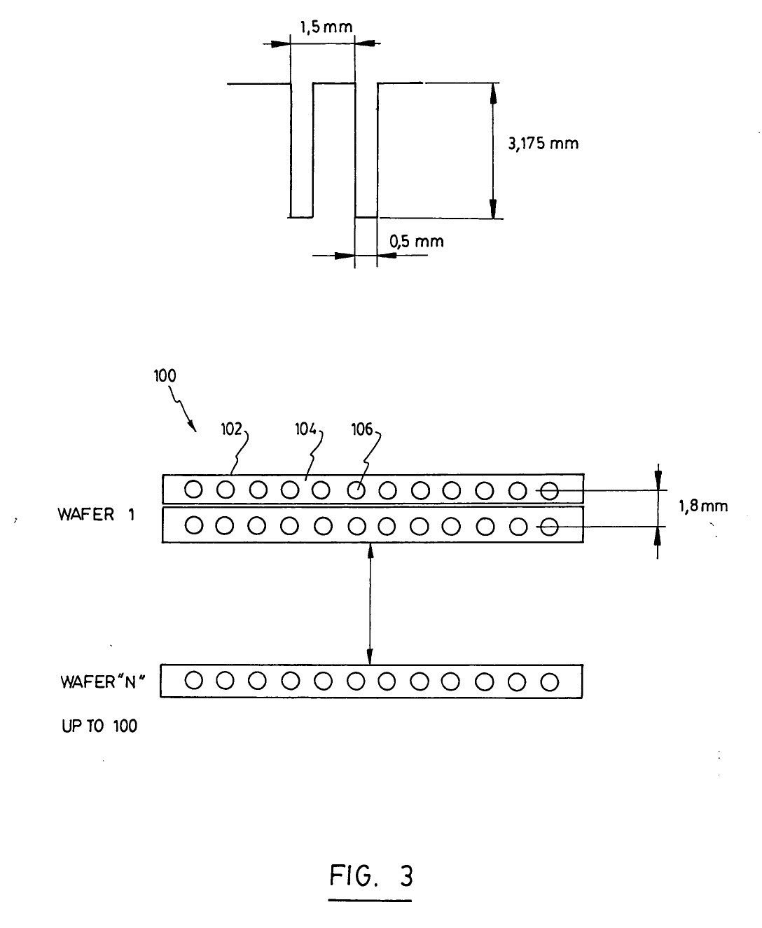

An example of a press fit connector 100 is shown in FIG. 3. The connector 100 comprises one or more wafers 104 having multiple pins 106. Each pin 106 has a diameter of 0.5 mm and depth of 3.175 mm in this example. In a different model of wafers, smaller or larger pins may be provided. The pin detection system 10 may be suitably used to inspect connectors having pins that are suitable for insertion into wells of about 0.35 to 0.75 mm diameters. Pins 106 are provided at 1.5 mm interval. The wells are plated with conductive materials. Multiple wafers 104 are aligned together so that pins 106 in neighbouring wafers 104 are spaced apart at 1.8 mm. Rather than combining multiple wafers, a single wafer may have a plurality of rows of pins. Pins 106 are inserted in the holes in one pressing operation. Connectors may have multiple pins 106, such as 1800 pins 106 pressed in one occurrence. Connects having different geometry may be used for different PCBAs.

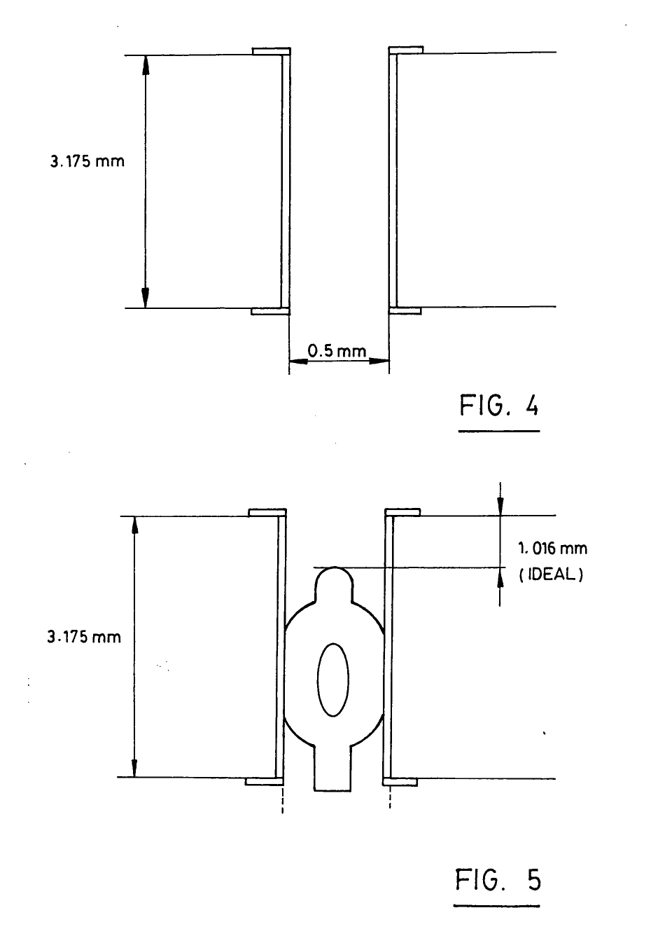

FIG. 4 shows a schematic partial view of a PCB 110 on which the connector 100 is connected using press fit pins 120 (FIG. 5). The PCB 110 has through holes or wells 112 coated with conductive material 114. This PCB 110 has a thickness of 3.175 mm. The diameter of the well 112 is 0.5 mm. Different PCBs may be used for different connectors and pins and wafer types. The geometries of PCBs and connectors are codified with the design center 32 as templates, once only for each pin/wafer/connector model, as further described below.

FIG. 5 shows an ideal insertion of a press fit pin 120 in the well 112 of PCB 110 when the connector 104 is mounted onto the PCB 110 from the bottom in this drawing. The press fit pin 120 has an insertion tip 122 and an enlarged section 124 with a hole 126. The enlarged section 124 has a diameter larger than the diameter of well 112 prior to the insertion into the well 112. When the press fit pin 120 is inserted into the well 112, the enlarged section 124 deforms to fit into the well 112. Different types of press fit pins may be used in different embodiments.

Ideally the press fit pin 120 is inserted into the well 112 so that a predetermined distance is left between the insertion tip 122 of the press fit pin 120 and an opening end 113 of the well 112. In this example, the predetermined distance is 1.016 mm.

Referring back to FIG. 1, the sensor 14 of the pin detection system 10 measures the distance between the insertion tip 122 of each press fit pin 120 and the opening end 113 of its respective well 112, i.e., the insertion depth of the press fit pin 120 in the well 112.

The sensor 14 measures the insertion depth of press fit pins 120 in wells 112, utilizing laser-based interferometer to measure distances. The sensor 14 emits a laser beam and detects reflected laser beam.

Laser-based interferometer permits a laser beam that is tight enough to enable focusing the beam on the tip of a pin that is recessed under the panel, without excessive artifacts due to beam that intersects at the opening end 113 of the well.

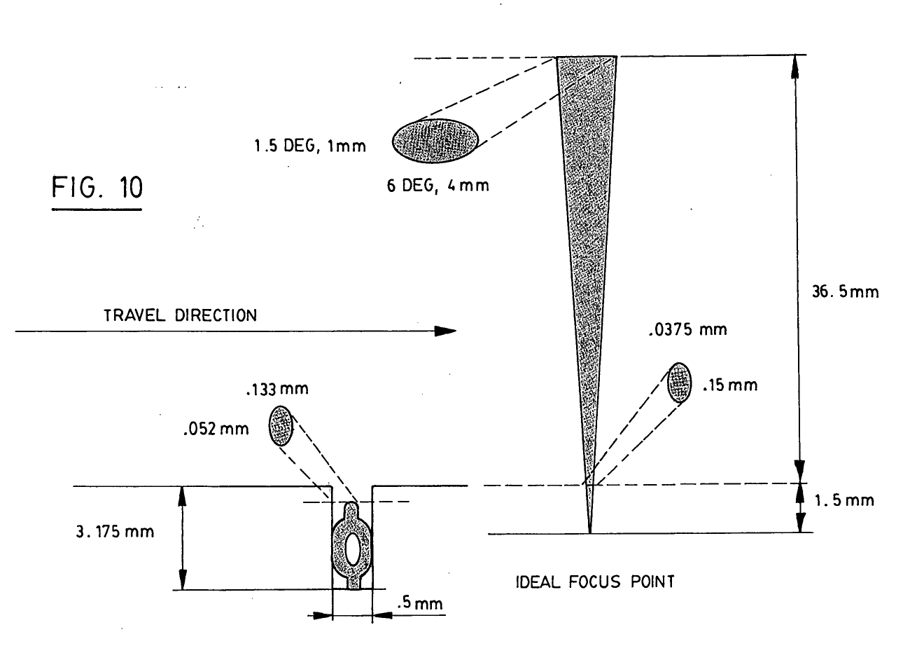

FIG. 10 shows an example of beam geometry that is suitably used for measuring a PCBA that embeds a connector having a press fit pin 120 with an insertion tip 122 of 0.0133 mm and 0.052 mm. The beam 150 has an ideal focus point of 38.0 mm. It has 1.5 degrees, 1 mm and 6 degrees, 4 mm at the emission end, and 0.375 mm and 0.15 mm at 1.5 mm from the ideal focus point.

The sensor 14 may be a holography measurement system in which an interference fringe pattern is encoded in the incident beam. By using such an interference fringe pattern, it is possible to eliminate the need for a mechanical system having moving part, which is costly, unreliable and slow, to adjust the so-called “reference” arm used in the interferometry technique. This type of sensor 14 permits high speed measurements, such as 20 measurements inside a typical well 112, while traveling rather fast on the surface.

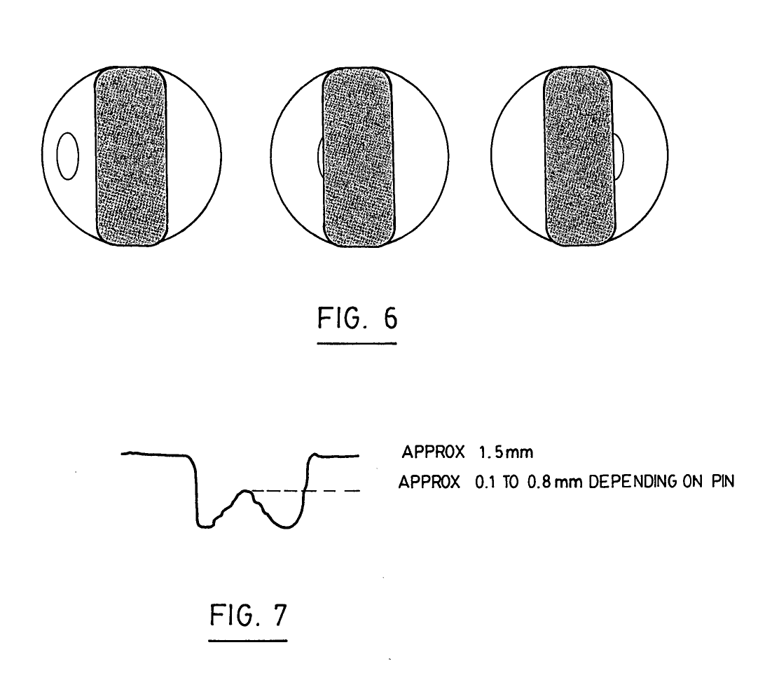

FIG. 6 shows an example of an operation of the sensor 14. The sensor 14 is operated to scan a well 112 from one edge to the diametrically opposite edge so that a laser beam 130 scans through the insertion tip 122 of the press fit pin 120 in the well 112. FIG. 7 shows an example of the detected reflection of the laser beam 130. Initially, the laser beam is reflected by the surface of the PCB 110, which is measured as approximately 1.5 mm in this example. The reflection drops when the laser beam 130 comes to an edge of the well 112 and then reach to a peak when the laser beam 130 reaches to the insertion tip 122 of the pin 120, which is typically measured as approximately 0.1 to 0.8 mm depending on the insertion of the pin 120. If the pin is missing, there will be no peak in the measurements.

The sensor 14 may obtain two types of measurement characteristics. For each data point, the sensor 14 may measure the distance to a focal point (D), as well as Signal to Noise Ratio (SNR). Whilst the D measurement could be enough for certain purposes, it is preferable to use SNR to refine the spatial registration of the point since the SNR measurement allows auto-correlation with the theoretical position of the wells. This supports the algorithms for spatial alignment and pin-computation, which are described below.

The pin detection system 10 carries out two types of measurements: point based measurements and trace based measurements.

The point based measurements are carried out when the pin detection system 10 uses the stage 16 to move the sensor 14 to a known location. The pin detection system 10 measures the (D/SNR) combo at that point. The measured (D/SNR) value is typically used in the following contexts:

When determining the reference height of the surface of the panel under test, near a region of interest (for example near a connector);

When adjusting the standoff of the laser so as to place the beam's focal point at the ideal position;

When re-measuring a specific pin's height, when the other processes have failed;

When re-asserting a “missing pin” defect classification, to provide multiple data points as objective evidence to the classification; and

When attempting to locate a hole's x-y coordinates.

The trace based measurements are carried out when the pin detection system 10 places the laser beam at a start point (Ps) and while traveling to an end point (Pe). The pin detection system 10 measures and captures a point every ΔX or ΔY units of distance. For example, when going from Ps=(1.0,2) to Pe=(2.0,2.0), the pin detection system 10 captures a point every 0.001 inches, thus performing 1001 measurements. The data are stored on a data storage, such as a disk, for later analysis of the trace content. The trace content obtained for the above example has

1, 1.000, 2.000, hh.h(1), nn.n(1)

2, 1.001, 2,000, hh.h(2),nn.n(2)

through

1001, 2.000, 2.000, hh.h(1001), nn.n(1001)

where hh.h is the distance from focal point in mils and nn.n is the signal-to-noise ratio for the data point.

The trace based measurements are used in a number of situations, such as:

When measuring an entire row of pins, for later bulk-computation;

When determining the location (x,y) of a hole in space;

When remeasuring a specific pin's height; and

When re-asserting a “missing pin” defect classification, to provide multiple data points as objective evidence to the classification.

In point-based measurements, the data is processed immediately to permit an instantaneous decision on the part of the adaptive algorithms, and thus permit a rapid inspection process.

In trace-based measurements, the data may be stored on disk or other data storage in a sequential file, for later analysis and processing.

Referring back to FIG. 1, the conveyer 15 ingress/egress PCBAs under test into or out of the pin detection system 10. When a PCBA is mounted on the conveyer 15, it ingresses the PCBA underneath of the sensor 14.

The stage assembly 16 controls the positioning of the sensor relative to the PCBA ingressed by the conveyer 15 so that the laser beam is brought to the area of interest on the PCBA.

The pin detection system 10 may use a adaptive motion system. The adaptive motion system permits to compensate for operational variations, and to perform inspections based on design data (invariant). The adaptive motion system has the following major functions:

The adaptive motion system implements the theoretical-to-actual transformation of coordinates in real time, discharging the detection system 10 from the responsibility of performing that task. Thus the Motion System adapts to variations in panel placement.

The adaptive motion system uses low cost part for the mechanical implementation of the motion system. These parts can have significant non-linearity or distortions. The adaptive motion system is programmed to compensate for these non-linearity and distortions, thus providing the benefits of very high positional accuracies (e.g., fewer than 0.1 mil in any axis).

Heavy parts on the PCB can cause the PCB under test to droop, causing significant variations of the reference plane height (PCB surface) over the inspection area. The adaptive motion system compensates for pre-measured droopiness and thus permits the recording of pre-flattened traces, at the appropriate reference plane height. This facilitates the computational burden of trace-based measurement analysis. Also, this extends the depth-of-field of the focused laser beam, since the focal point is always at the exact optimal distance from the PCB surface. Deeper pins can be measured.

The preferred embodiment uses the adaptive motion system to compensate for motion related operational variations. Alternative embodiments may use more expensive motion system components (such as high precision screws, linear motors) to improve positional accuracy, or may use a levelling piston to straighten the PCB under test, thus eliminating the need to adapt to surface curvature.

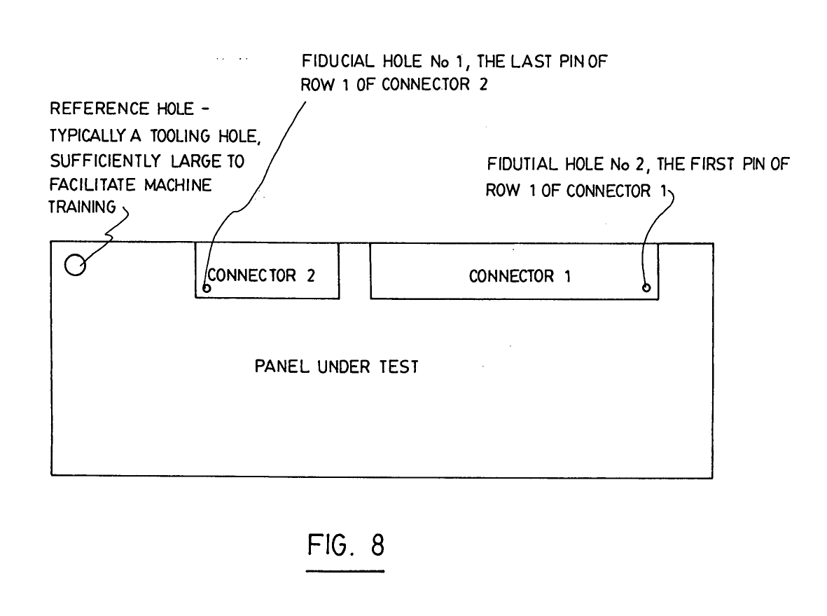

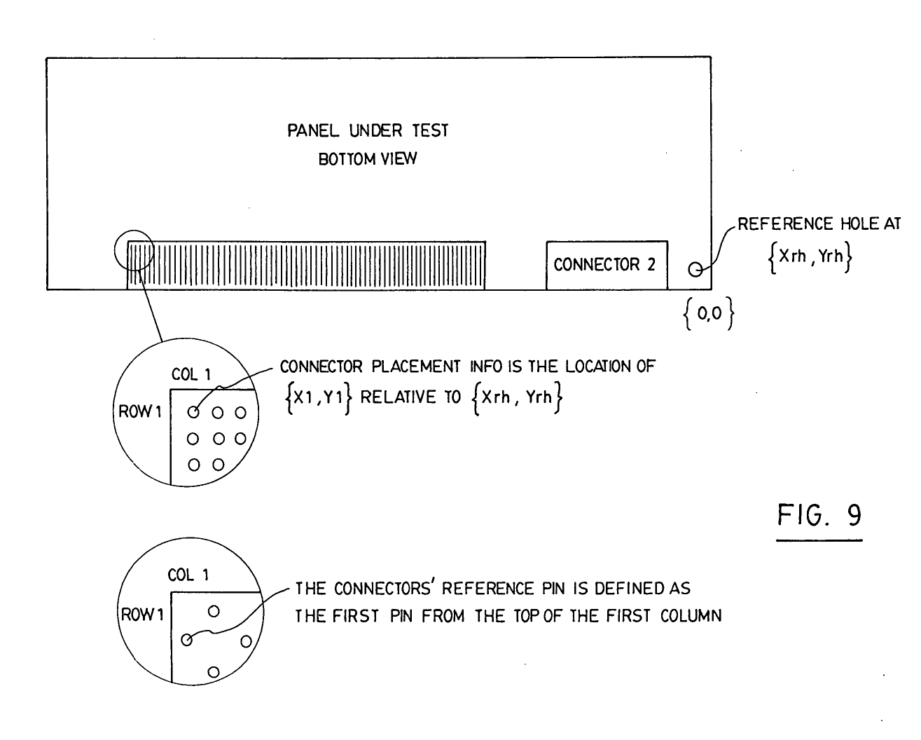

As shown in FIG. 8, when a PCBA or panel under test 140 is mounted on the conveyer 15, the detection controller 12 performs a panel registration process to register the panel 140. The panel registration process may be carried out using a reference hole 142 on the panel 140, such as a tooling hole, that is sufficiently large to facilitate machine training. Also the panel registration process uses two fiducial holes 144 and 146. The first fiducial hole 144 may be the last pin location of the first row of connector 2, and the second fiducial hole 146 may be the first pin location of the first row of connector 1.

The inspection process starts with panel registration when a PCBA under test or panel 140 is placed on the ingress/egress conveyor 15, and the panel edge that contain the connectors is firmly set at the back of the pin detection system 10, under the optimal zone where the laser system of the sensor 14 can perform measurements. There are a number of operational considerations that may affect the resting position of the panel after the ingress. Typically, the panel may be off by more than 60 mils in the Y axis, and may be rotated by up to 2 degrees. For accurate measurement processes (trace-based and point-based measurements), it is important to have accurate registration in x, y coordinates or every data point. It is preferable that an offset is fewer than 2 mils in any axis. The panel registration process permits the pin detection system 10 to tend to the accuracy requirements.

The panel registration process include the following steps:

Calculate vector Vi from tooling hole reference to fiducial hole 1 (pin nearest to the toolinghole)

Find F1 at Vi using FindHoleTraceBasedAlgo

If F1 Found trace based
calculate vector Vi from tooling hole reverence to fiducial hole 2 F2 (pin furthest from tooling hole)
Find F2 at Vi using FindHoleTraceBased algo
If F2 found trace based-end algo
Find F2 point-based
If F2 found point-based end algo
if F2 not found—inspection failed

If F1 not found trace based
Find F1 point-based
If F1 Found
   calculate vector V1 from tooling hole reverence to fiducial hole 2 F2 (pin furthest from tooling hole)
   Find F2 at Vi using FindHoleTraceBased algo
   If F2 found trace based-end algo
   Find F2 point-based
   If F2 found point-based end algo
   if F2 not found—inspection failed
if F1 not found—inspection failed
   FindHoleTraceBasedAlgo involves the following steps:

Calculate trace start point
Vs(x)=Vi(x)
Offset Vy by Hole Diameter (Hd)+Hole Pitch Py to stand off from the position of the hole
Vs(y)=Vi(y)+Hd/2+Hp

Position stage at Vs

Calculate position just outside the hole in Y axis
Vf(x)=Vi(x)
Vf(y)=Vi(y)−Hd/2

Perform a trace From Vs to Vf

Analyse trace to determine presence of a Well (algo to follow later). Compute Well centerpoint along Y Wy and Well Diameter Wd
If Wd=0, FindHoleTraceBased failed

Calculate X axis trace start point
Vs(x)=V1−Hd/2−Hp
Vs(y)=W(y)

Calculate X axis trace end point
Ve(x)=Vi+Hd
Ve(y)=Wy

Perform a trace from Vs to Ve

Analyse trace to determine presence of a well, Compute well centre point along Y Wx and Well diameter
if Wd<Hd*.4, FindHoleTraceBased failed
if Wd>=Hd*.4 report hole location as Wx,Wy

The database 18 contains information of PCBAs.

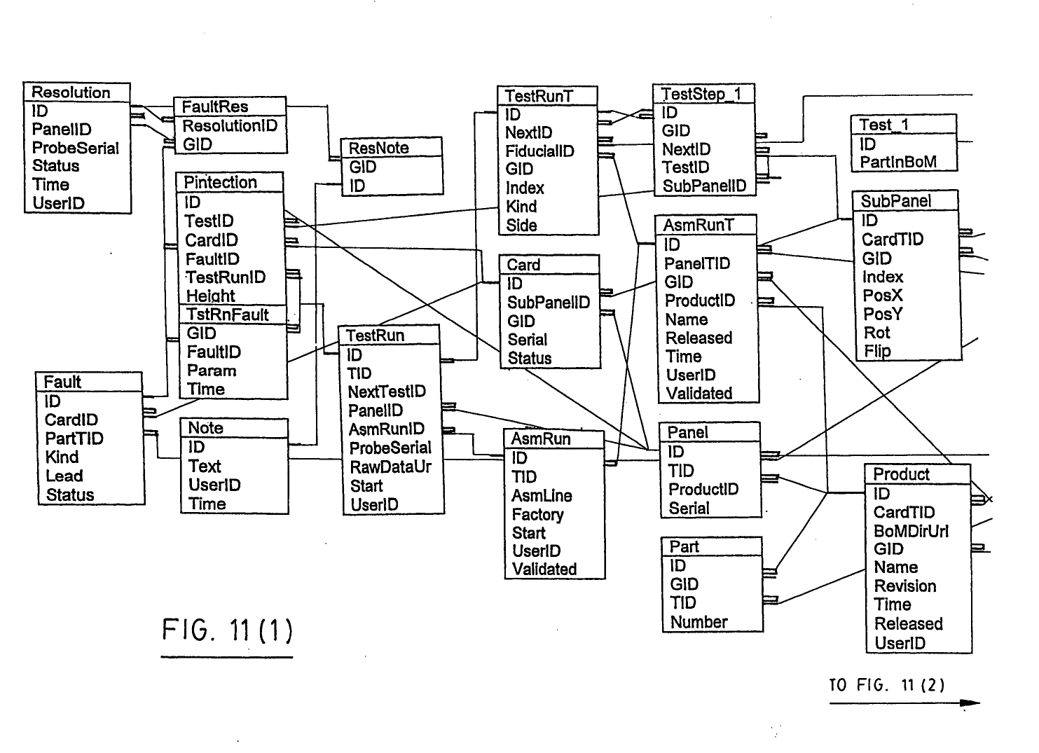

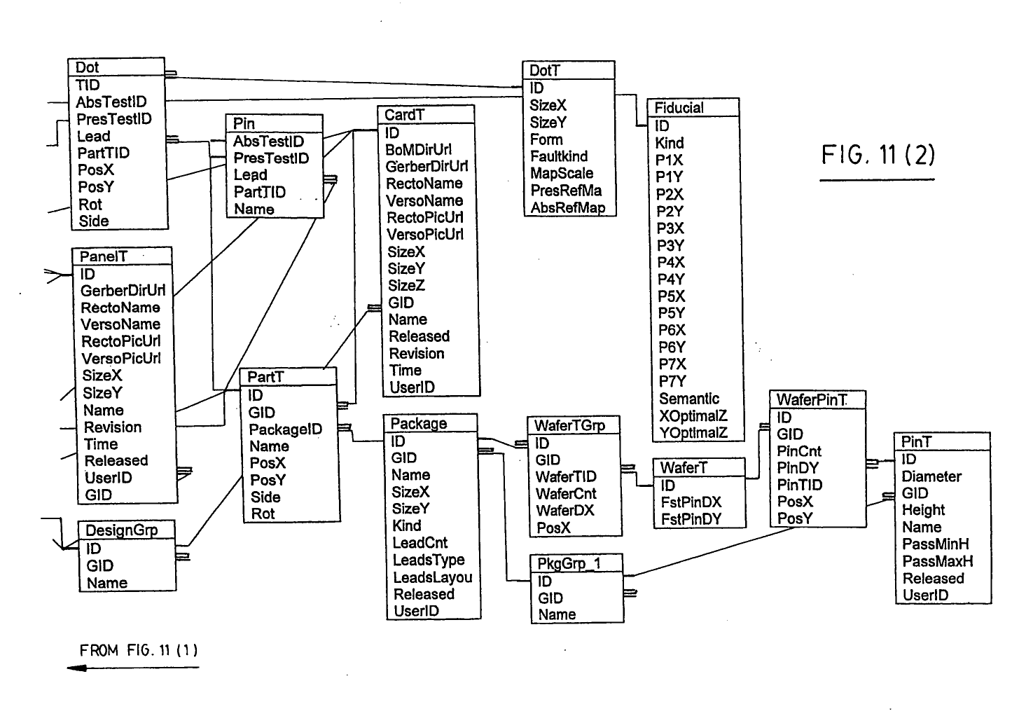

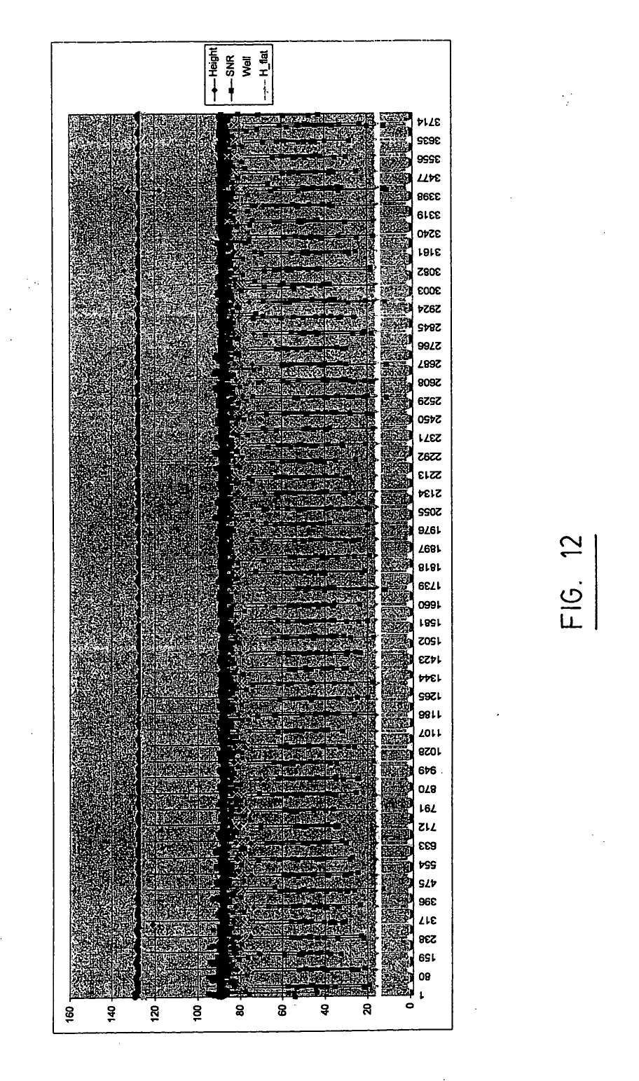

FIG. 11 shows an example of the data structure in the database 18. In FIG. 11, the table name is shown at the top of each box representing the table. When a table has “_{—}1”, “_{—}2” suffix, it has been visually duplicated to declutter the diagram. The table contains product design information for PCB assemblies of interest. Some tables are templates (the name ends with “T”). Templates are re-useable.

There are also templates that describe the physical aspects of how a connector is assembled. These are the PinT, the WaferT, and the WaferPinT. The wafer contains nn pins (e.g., 9,12,15 in the Tyco (trademark) family). The WaferT describes the physical characteristics of each wafer (no of pins, size). The WaferPinT describes the location of each pin in the wafer.

The WaferTGrp represents templates for common assemblies of wafers into placeable parts (25 wafers, 35 wafers, etc).

When a WaferTGrp is used in a PCB layout, it becomes a Part. Parts have templates (describing their complete size, relationship to panel geometry), and every time a PCB is inspected, a Part is created to denominate exactly the part being inspected.

Assemblies are used to represent the many ways in which a PCB can be inspected. For example, if a PCB is inspected after bulky parts are soldered (for example, when a PCB is returned with a defect), the PCB is placed in a placeholder to permit proper ingress/egress operations. This notionally alters the PCB geometry (size, perceived height), and the pin detection system 10 may be programmed for this scenario. The same product (PCB) could have inspected during the manufacturing cycle, with no placeholder. The pin detection system 10 may be programmed for this scenario, too.

The system programmer uses the design centre 32 to enter into the database 18 all the information needed to describe a PCB, its connectors, wafers and pins, and assemblies. After the data has been applied to the database 18, the pin detection system 10 can read the design information and compose a test script.

Since each PCB is notionally different, and because it is desirable to have a generic solution, it is preferable to describe efficiently in a database the design. When the pin detection system 1 is started, and a product is scheduled for inspection, the database 18 is consulted, and a test script is composed to inspect all the connectors that are present on the PCB. This test script (Adaptive Test Scripting, as further described below) is used by the detection controller 12 to sequence actions of the stage assembly 16 and the sensor 14 and perform measurements for all the pins described in the database 18 for the PCB under test. At the end of the inspection process, the detection controller 12 commits the inspection results in the Pintection table of the database 18, and present them on the user interface 20. The user can then choose to eject the panel, or re-inspect selected pins.

The database 18 also contains information about the measurements (Pintection), the classification of measured pin heights (in Pintections) into faults when appropriate, and the resolutions of faults when the repair operator affects repairs to the PCB.

The repair centre 34 can be used to query the database 18 to determine the location of the pins/wafers/connectors that are in need of repair, and update the fault status information of the database 18.

The preferred embodiment uses database 18. Alternative embodiments may include such strategies as:

text based description of the pin locations per product

xml based representation of the object model similar to the one in the database

an entirely different object model (for example based on the holes)

Adaptive test scripting is a strategy to permit the most operational flexibility with respect to the variability of operational constraints:

The purpose of the script is to perform the inspection in a manner that is congruent to here-and-now operational conditions, while permitting the persistence of inspection data in the database that is referenced to the actual design parameters. Thus, the pin detection system 10 provides two major benefits:

The pin detection system 10 can inspect in the face of significant operational flexibility and variances

The pin detection system 10 can report results in a manner that is consistent, thus permitting later data mining. The fault and measurement information is referenced to design objects that do not change with PCB serial, or PCB assembly.

A script is composed when each panel is ingressed by consulting the database 18 and generating in a scripting language a series of instructions to coordinate the actions of the stage assembly 16, the sensor and the database 18 engine. The script can adapt to the inspection sequence to:

Variations in panel resting positions after the ingress. The panel is referenced in space, and a mapping of the “actual” plane to the “theoretical” plane is computed. The instructions of the script are always in “theoretical” coordinates, but commands are issued to the stage assembly 16 to perform appropriately the Theoretical-Actual transformations;

Variation in panel assembly configuration (jig, no jig, PCB cut-outs or not, break-outs or not); and

Finally, the script is adaptive to the scope of testing desired. When an assembly line has more than one detection system, each system could be tasked with inspecting a particular subset of the pins (for example if the inspection were too long, this is a viable operational scenario). The scripts thus permits scope adaptations, that can be commanded and effected in real-time with the user interface.

The preferred embodiment implements an application specific syntax and language. Alternative embodiments may use well known scripting language frameworks, such as Perl, Python, J-Script.

The operation of the pin detection system 10 is now described in detail.

The pin detection system 10 is equipped with a panel ingress/egress conveyor 15 and a stage assembly 16. Once the pin detection system 10 has been trained to inspect a specific product, the inspection process uses the following steps for each PCB under test or panel:

The panel is ingressed into the pin detection system 10, after having scanned the serial number with, e.g., the integrated bar-code reader of the pin detection system 10.

The machine operator clicks a button to trigger the inspection process.

The pin detection system 10 then moves to two fiducial holes in sequence. The fiducial holes are both part of the panels' connectors.

The fiducial hole nearest to a pre-programmed tooling hole and the fiducial hole furthest from the tooling hole are scanned to precisely determine the panel location, as it is situated after the conveyor 15 has completed the ingress operation. For these scans, the pin detection system 10 first uses the trace based measurement, and if fails, it uses a point based measurement.

Each connector is then inspected sequentially, starting with the furthest connector from the reference hole. The inspection of each connector is performed as a series of scans parallel to the edge of the PCB. The pin detection system 10 uses trace based measurement for each scan. The pin detection system 10 performs one scan for each row of pins of the connector.

After all rows of all connectors have been scanned, the results of the scan are written to the database 18. The pin detection system 10 may then perform one (or both) of the following tasks, depending on the results of the measurement process:

Re-scan a row entirely using the trace based measurement, when a large number of measurements within a single row are not sufficient to make a pass/fail determination. Each suspect row is re-examined. The database 18 is updated with the new measurement data; and/or

Re-scan a number of pins individually using the point based measurement, when suspect measurements are detected at disperse locations. After each pin is re-assessed, the database 18 is updated.

A PASS/FAIL determination is made for the entire panel. The machine operator can then choose to rescan specific pins, or eject the panel and commit the data to the database 18.

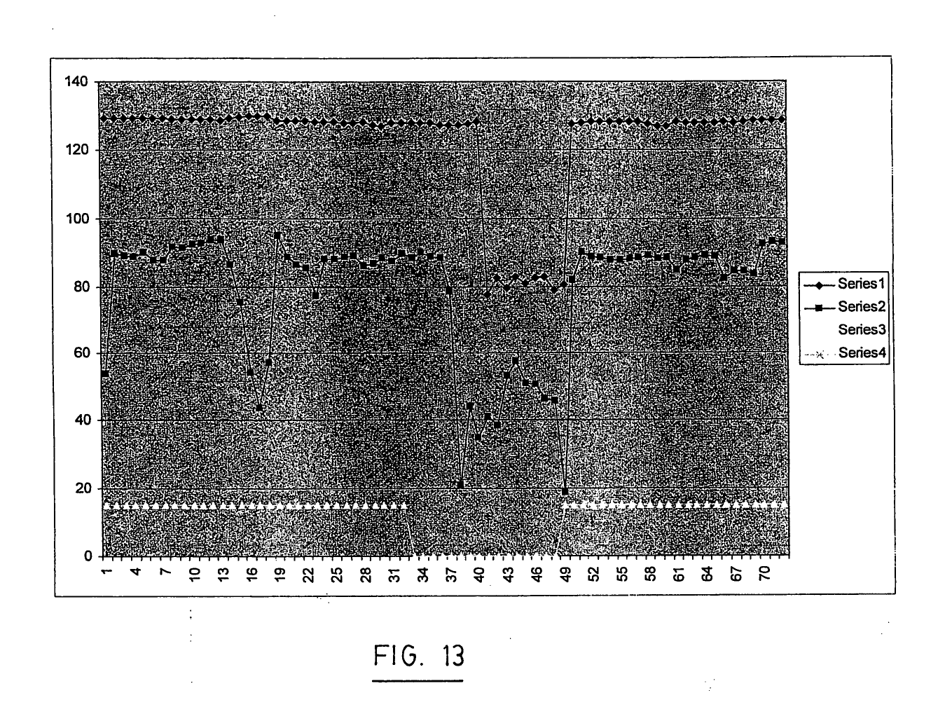

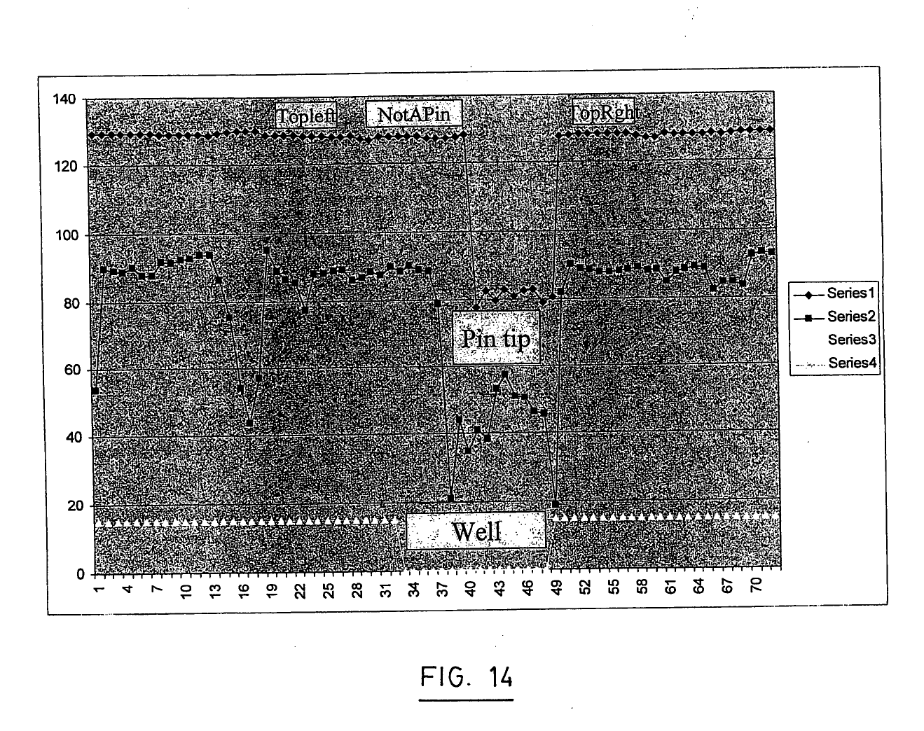

The pin height detection algorithms are further described in detail with reference to FIGS. 12-14. FIG. 12 is an example of trace measurement results. FIG. 13 shows a view of a section in FIG. 12 which corresponds to a well. FIG. 14 is a copy of FIG. 13 in which the terms used in the algorithms are shown.

Well—the hole in which the pin is inserted

NotAPin—a series between the wall of the well and the pin; looks like top (Height) but is not (low SNR)

TopLeft—the PCB surface near the well on the LHS of the well

TopRight—the PCB surface near the well on the RHS of the well

Pin—actual points measured on the pin tip

The PinHeight algorithm consists of five successive computational phases as described below:

Phase 1—PinHeightAlgoSeed

Scan entire trace to plot the theoretical position of wells (from DB 18)

For each Well in Wells
Compute TopLeft height (average 5 points)
Compute TopRight height (average 5 points)
Linearly interpolate points in well based on TopLeftH and TopRightH (turquoise trace)
Eliminate NotAPin points based on SNR
   Point height near top average value (±5)
   Position within the well's theoretical position
The points left are PointsInWell collection of points
   Phase 2—PinHeightAlgoPointsInWell

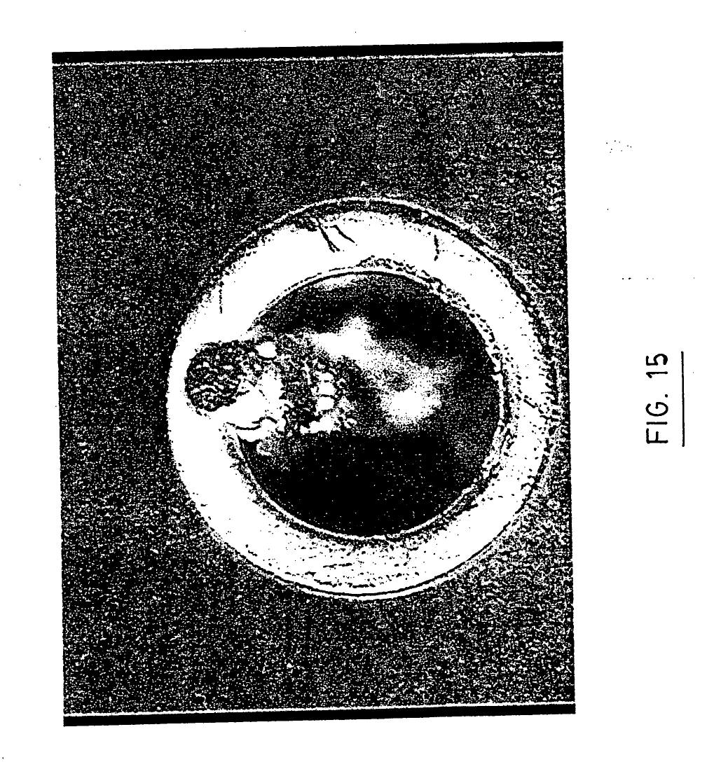

For each Point in PointsInWells
Compute centroid of pin tip
Eliminate high outliers near the center of the pin tip
Eliminate high outliers between PinH nominal +5 and Top −5 (caused by copper deposits near the edge of the well shown in FIG. 15)
Eliminate low outliers near the edges of the pin tip (sometimes laser catches a point very low, but still on the pin's wall)

Points left are MeasuredPointsInWell

Phase 3—PinHeightAlgoClassifyPin

For each Point in MeasuredPointsInWell
Locate top—3 points with the best SNR
Average the height of the three points
Report Height
If 3 points were left
   Report “good” measurement quality
Otherwise if 1 or 2 points
   Report “few points” measurement quality
Otherwise
   Report “missing pin” measurement quality
      Phase 4—PinHeightAlgoReinspectRows

For each Row
If No of pins<theoretical no of pins in row
   Schedule row for re-scan
If No of “no pins”>5
   Schedule row for re-scan

For each Scheduled row
Perform re-scan with lower focal point
Perform Phases 1, 2, and 3
   Phase 5—PinHeightAlgoPinReinspects

For each pin measurement
If quality is “good” or “few points”
   If height>MinPass criteria and Height<MaxPass criteria
      Record in database 18
   Otherwise
      Place pin ID in Pin ReMeasure Collection
If quality is “missing pin”
   Place pin ID in Pin ReMeasure collection

For each pin in ReMeasure collection
Perform PointBased inspection
Classify pin (Phase 3)
Commit final result to database 18

As the pin detection system 10 uses laser based technology, it is possible to eliminate the use of mechanical means, such as pin gages, to inspect pin insertion depth. The pin detection system 10 can inspect small pins inserted in small wells, such as 0.016″ diameter wells. Also, the pin detection system 10 can inspect shallow pins: In order to prevent Radio Frequency emission leakages from one pin to the other, the assembled pins are voluntarily kept recessed under the surface of the finished PCBA; The pin detection system 10 can inspect tightly packed pins, such as pins having the pin-to-pin distance of 0.075″ or smaller.

As the pin detection system 10 scans pins at a speed compatible to the PCBA assembly line cycle time, it can inspect all pins of connectors. The PCBA assembly line cycle time is typically in the order of minutes, whilst existing inspection techniques may require hours to complete. For example, in an embodiment, the pin detection system 10 moves at a rate of 5 inches per second and can easily scan pin depths of up to 100 mils. The system can accommodate board sizes of up to 20 inches×20 inches.

The pin detection system 10 can be adaptable to inspect diverse connector assemblies. The lattice of pins in a connector assembly, as well as the pin configurations vary significantly from one manufacturer to the other, as well as from assembly to another. The pin detection system 10 permits the efficient definition of many different possible configurations, and their placement in the inspection database 18.

Measurement reporting is space-based, as opposed to time-based, permitting highly predictable and repeatable algorithmic analyses of the data streams.

The pin detection system 10 allows a technician to easily identify pin insertions that fall outside specification and to perform any necessary repair. PCBAs with multiple high-density connectors are easily handled by the pin detection system 10 using data from a standard Gerber file to orient itself with respect to the panel.

In the above embodiments, the panel registration is done with using the depth sensor. An alternate embodiment may use a machine vision system to locate the centroids of the holes, using a camera, video image grabber and image pattern matching algorithms in addition to the laser-based subsystem.

The pin detection system and detection suite of the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

1. A pin detection system for detecting connection pin insertion in a printed circuit board assembly, the system comprising:
a conveyer for conveying a printed circuit board assembly under test, the printed circuit board assembly comprising a printed circuit board having multiple wells and one or more connectors having pins that are inserted into the wells of the printed circuit board; and
a sensor for detecting pin insertion in the wells using a laser beam.

2. The pin detection system as claimed in claim 1, wherein the sensor is a laser based interferometer.

3. The pin detection system as claimed in claim 1 further comprising:
a detection controller for controlling the detection of pin insertion by the sensor and processing the measurement data provided by the sensor.

4. The pin detection system as claimed in claim 3, wherein the detection controller registers the position of the printed circuit board assembly under test and retrieve information of the printed circuit board assembly from the database.

5. The pin detection system as claimed in claim 3, wherein the detection controller uses an adaptive motion system for controlling the relative motion data of the laser beam at specific areas of surface of the printed circuit board assembly under test

6. The pin detection system as claimed in claim 3, wherein the detection controller processes the sensor data using pin height algorithms.

7. The pin detection system as claimed in claim 3, wherein the detection controller uses adaptive test scripting.

8. The pin detection system as claimed in claim 3 further comprising:
a database for storing information of the printed circuit board assembly.

9. The pin detection system as claimed in claim 1 further comprising:
a stage assembly for positioning the sensor 14 in relation to the printed circuit board assembly under test

10. The pin detection system as claimed in claim 1 further comprising:
a design centre connected to the pin detection system through a network, the design centre allowing a user to design printed circuit board assemblies and providing information of the designed printed circuit board assemblies to the pin detection system.

11. The pin detection system as claimed in claim 1 further comprising:
a repair centre connected to the pin detection system through a network, the repair centre allowing a user to access the pin detection system to obtain pin detection results.

12. A method of detecting connector pin insertion in a printed circuit board assembly, the method comprising the steps of:
conveying a printed circuit board assembly under test, the printed circuit board assembly comprising a printed circuit board having multiple wells and one or more connectors having pins that are inserted into the wells of the printed circuit board; and
detecting pin insertion in the wells using a laser beam.

13. The method as claimed in claim 12, wherein the detecting step uses a laser based interferometer.

14. The method as claimed in claim 12 further comprising the step of:
controlling the detection of pin insertion; and
processing detected data.

15. The method as claimed in claim 12 further comprising the step of:
registering the printed circuit board assembly under test in space.

16. The method as claimed in claim 14, wherein the controlling step uses an adaptive motion system for processing relative motion data of the laser beam.

17. The method as claimed in claim 14, wherein the controlling step detects the pin insertion using pin height algorithms.

18. The method as claimed in claim 14, wherein the controlling step uses adaptive test scripting.

19. The method as claimed in claim 14 further comprising the steps of:
storing information of the printed circuit board assembly, and
controlling the pin detection using the information.

20. The method as claimed in claim 12 further comprising the step of:
positioning the sensor 14 in relation to the printed circuit board assembly under test.

21. The method as claimed in claim 12 further comprising the steps of:
receiving information of the printed circuit board assembly from a design centre through a network, and
controlling the pin detection using the information.

22. The method as claimed in claim 12 further comprising the step of:
sending detection results to a repair centre through a network for repairing if the detection results of the printed circuit board assembly indicate a pin insertion defect.
